(19) United States
(12) Patent Application Publication
(10) Pub. No.: US 2008/0018494 A1
(43) Pub. Date: Jan. 24, 2008

(54) Traffic Sign Beacon System

(76) Inventors: Robert K. Waite, Holden, MA (US); John M. Juby, Adams, MA (US)

Correspondence Address: Brian M. Dingman, Esq.;Mirick, O'Connell, DeMallie & Lougee, LLP\, 1700 West Park Drive, Westborough, MA, 01581-3941, US

(21) Appl. No.: 11/781,316

(22) Filed: Jul. 23, 2007

Related U.S. Application Data
(60) Provisional application No. 60/820,125, filed on Jul. 24, 2006.

(51) Int. Cl. G08G 1/095; H04B 3/36

(52) U.S. Cl. 340/907; 340/10.1; 340/407.1; 340/539.1; 340/815.45; 340/917; 340/944

(57) ABSTRACT

A vehicle warning system for use in conjunction with road signs proximate a roadway and that are visible by passing motorists. The system has two assemblies, one on each side of a roadway and associated with a road sign. Each assembly has a power source, one or more lights that when lit project light that is visible to a passing motorist, a controller, a light activation device, and a wireless transceiver. Operation of the light activation device of a first of the assemblies causes the wireless transceiver of the first assembly to send a signal to the wireless transceiver of the second assembly, and both controllers to temporarily connect one or more lights of each assembly to the power source for the assembly, to light the one or more lights and thus project light that is visible to the motorist from both sides of the roadway.

### CROSS-REFERENCE TO RELATED APPLICATION

This application claims priority of Provisional Application Ser. No. 60/820,125, filed on Jul. 24, 2006, the entire contents of which are incorporated herein by reference.

### FIELD OF THE INVENTION

This invention relates to a warning system associated with traffic signs.

### BACKGROUND OF THE INVENTION

In the United States in recent years approximately 72,000 injuries and 5,000 deaths have occurred in signed, marked crosswalks, and these numbers increase yearly.

According to the Federal Department of Transportation (DOT), the purpose of crosswalk signs is to create driver awareness of a specific traffic situation, i.e. a pedestrian crossing the street. The DOT defines, in its Manual on Uniform Traffic Control Devices (MUTCD), the event of drivers' reaction as PIEV Time. PIEV stands for Perception (awareness), Identification (understanding), Emotion (decision making) and Volition (execution of decision).

Prior art includes various devices such as flashing yellow lights and flashing lights buried in the road itself. All suffer from compromises and lack of universal geographical applicability.

### SUMMARY OF THE INVENTION

The invention advances the state of the art in creating driver awareness of pedestrians in crosswalks and of other hazards close to either permanent or temporary road signs, such as men working in or near the roadway. One embodiment of the invention operates in an environment of a crosswalk warning sign system consisting of a minimum of two sign assemblies, installed on opposite sides of a street adjacent to a crosswalk, with the sign faces disposed to face traffic, and installed at the U.S.D.O.T. standard required height. The standard sign can be enhanced by adding an identical sign placed back-to-back with the first sign and with a reversed “walking man” image on the back, creating dual signage on both sides of the road. The assembly in this embodiment can be attached along the top edge of this “sandwich” of signs nearest the road, with additional parts extending down the signpost for the pedestrian pushbutton and upward above the normal height of the signpost to hold the LEDs that illuminate the crosswalk, and the solar panel if used.

When a pedestrian desires to cross the street, the pedestrian activates the pushbutton, which causes the local control processor to determine if an RFID or other user identification device is present and if so to react by changing the display behavior accordingly. If not, it begins a standard display. In either case, the activated assembly sends a radio message to the sign on the other side of the road to begin its flashing sequence, indicating what type, and for how long, and other control information as needed.

If a message is received from a remote control device, or a coded pushbutton sequence is entered via a user pushbutton, a wider variety of display behaviors and communication options are available. The same is true, should contact be made via cell phone.

This invention features a vehicle warning system for use in conjunction with road signs that are located alongside a roadway. The system typically has two assemblies, one on each side of a roadway and associated with a road sign. In some cases, such as with a hazard sign on only one side of a roadway, for example, a single assembly can be used. Each assembly has a power source, one or more lights that when lit project light that is visible to a passing motorist, a controller, an activation device, and typically a wireless transceiver. Operation of the activation device of a first of the assemblies causes the wireless transceiver of the first assembly to send a signal to the wireless transceiver of the second assembly, and both controllers to temporarily connect one or more lights of each assembly to the power source for the assembly, to light the one or more lights and thus project light that is visible to a motorist on the roadway. In one embodiment, each assembly may be in one or more parts that are mounted to a sign, and/or to a post to which a sign is mounted.

The power source may comprise a battery to store energy. The power source may further comprise a solar collector that can be used to directly power the assembly, and also to re-charge the battery. The activation device may comprise a pedestrian sensing device. The pedestrian sensing device may be manually operable by a pedestrian (such as an electromechanical push-button or a capacitive or touch-screen sensor, for example), or it can be automatic (such as a motion detector). Each assembly preferably has a number of lights. One or more of the lights may be pedestrian safety lights that are angled downward and aimed at the roadway near the sign; these are typically used for crosswalks, to illuminate a pedestrian located in the crosswalk. The safety lights may be mounted above the sign. The safety lights may be in one or more housings with adjustable aim. One or more other lights may be vehicle warning lights that are typically directed along the roadway, in the direction of a vehicle approaching the sign. The vehicle warning system may comprise a plurality of vehicle warning lights. These lights may be mounted along an edge of the sign. The vehicle warning lights may be lit sequentially. At least some of the lights may be LEDs. The vehicle warning system may further comprise an ambient light sensor that is used to control the brightness of the lights.

The vehicle warning system may further comprise a wireless remote control for providing commands to a controller. The vehicle warning system may further comprise a speed-determination device that determines the speed of an oncoming vehicle. The vehicle warning system may further comprise a wireless communications device, responsive to the speed-determination device, that transmits a message related to the determined speed. The communication device may communicate a desired action to a vehicle. The desired action may include one or more of pre-tensioning seat belts, pre-charging or activating the brakes, and sounding the horn, for example. The message may be audible and/or visible to a driver.

An action of the system may be automatically controlled by detecting a nearby RFID device with a predetermined ID code. The vehicle warning system may further comprise a wireless communications device to allow one-way communication to, or two-way communication with, a remote site. The vehicle warning system may further comprise vehicle speed or velocity determination equipment to determine the speed or velocity of a vehicle on the roadway. An informational signal related to the speed or velocity may be communicated to the vehicle. The vehicle warning system may further comprise a device that broadcasts the activation state and location of an assembly. The broadcast may employ satellite communications. The vehicle warning system may further comprise a personal device carried by a pedestrian to identify their status as a user for whom the system behavior can change. The personal device may allow the user to enable an assembly. One or more aspects of light control can in some cases be controlled by a user. This may be accomplished through coded pushbutton entry sequence, remote control, or downloaded control via cellular telephone or satellite. The coded pushbutton sequence may be changed or disabled using a remote control device.

### BRIEF DESCRIPTION OF THE DRAWINGS

The foregoing and other objects, features and advantages of the invention will become apparent from the following description in conjunction with the accompanying drawings, in which common reference numbers refer to the same parts throughout the different views. The drawings are not necessarily to scale; emphasis has instead been placed upon illustrating the principles of the invention. Of the drawings:

FIG. 1 is an electronic block diagram of a vehicle warning system of this invention;

FIG. 1A is a more detailed block diagram of portions of one assembly of the system of FIG. 1;

FIG. 2 is a block diagram of an embodiment in which an approaching vehicle is warned;

FIG. 3 is a block diagram of an embodiment in which an approaching vehicle is detected and warned;

FIG. 4 is a block diagram of an embodiment in which the velocity of an approaching vehicle is detected, and the operator is warned; and

FIG. 5 shows an embodiment of an assembly for this invention mounted to a crosswalk sign.

### DETAILED DESCRIPTION OF THE INVENTION

The vehicle warning system comprises at least two assemblies, one on each side of a roadway and associated with a MUTCD-approved existing sign of the recommended shape, color, graphics, and size. In one non-limiting embodiment of the invention, the invention is used at a pedestrian crosswalk and the signs are approved crosswalk signs.

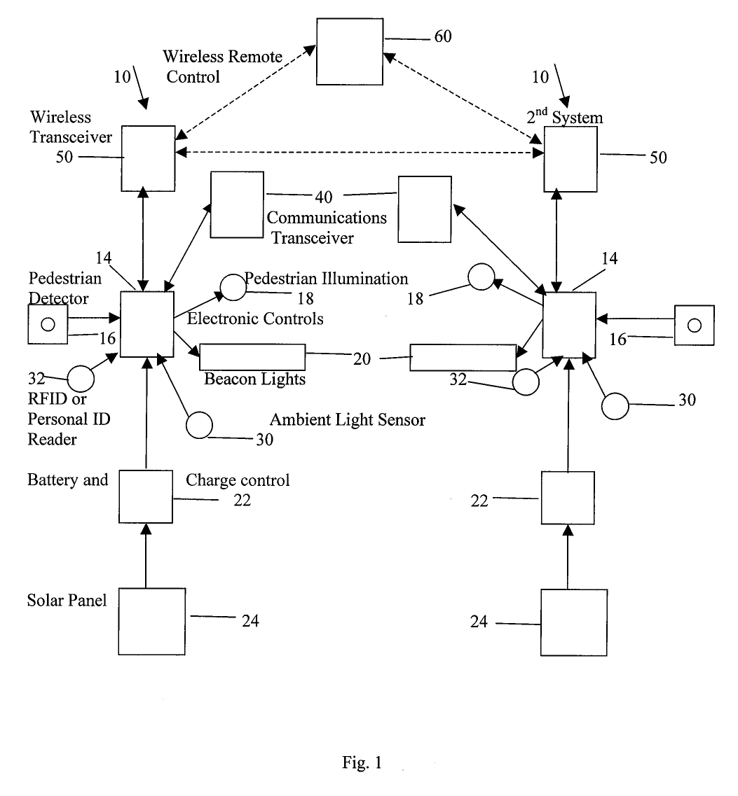

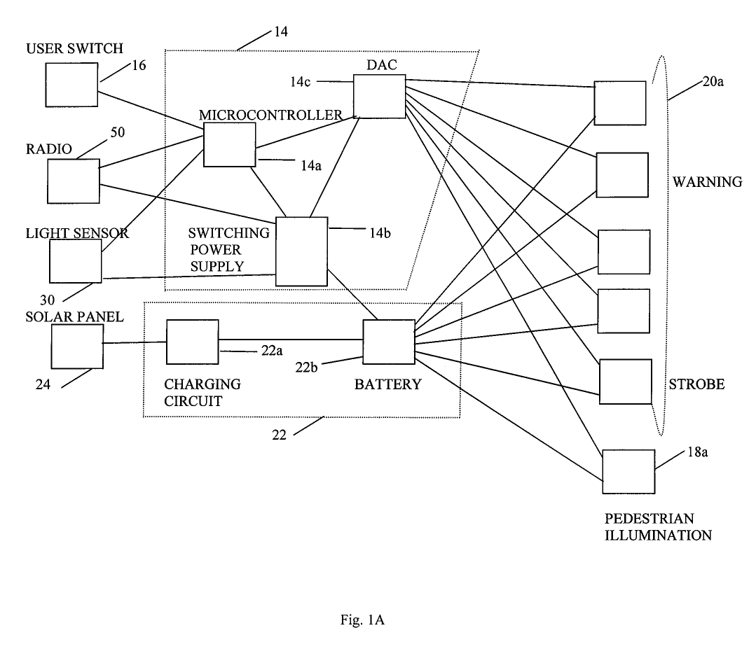

An assembly 10, FIGS. 1 and 1A, comprises beacon LEDs 20 that project along the roadway so as to be visible to motorists, pedestrian illuminating LEDs 18, battery with charge control 22, solar panel 24, a solar panel support bracket (not shown), electronic control unit 14, and pedestrian push button 16, which may be secured to the rear of the sign. The solar panel is adjusted so that it faces south in the northern hemisphere or north in the southern hemisphere and secured there at an appropriate elevation. The pedestrian push button is secured to the signpost at the correct height for best pedestrian access. Note that lights other than LEDs can be used.

An identical assembly 10 is secured to the crosswalk sign on the opposite side of the street. The two assemblies can be operated in a “learning mode” through their wireless transceivers 50 to configure them to communicate as a pair and ignore any other similar assemblies within radio range. The system is then ready to use.

In operation, a pedestrian who desires to cross the street pushes the pedestrian pushbutton on his side of the street. This action causes a series of beacon LEDs 20 to flash across the width of both sides of the local sign in a “theatre marquee” style which is timed to a similar flashing pattern on the opposite side of the road, indicating the direction of intended travel of the pedestrian while attracting attention to the crosswalk. Illuminating LEDs 18 also turn on to illuminate the crosswalk, and any pedestrians in it, from both sides of the road. After a predetermined interval all illumination turns off. The battery and solar cell combination provide for rapid recharge and several days of reserve capacity for typical usage patterns.

Options for this aspect of the invention, some of which are further explained below, include:
Communication between signs can be by radio, optical, wire, ultrasound or other means, or any combination thereof.
Beacon light flashing patterns and locations may change; they may be any color or colors or lighting technology; constant sign illumination may be used also.
Pedestrian illumination may flash and/or be constant.
Pedestrian sensing may be via an eletromechanical or electronic “pushbutton”; it may alternatively be non-contact, e.g., using ultrasonic, optical, or capacitive sensing.
The operating time for each illuminating period may be adjustable.
It may be possible to “re-trigger” and extend the operating interval by re-activating the pedestrian sensing before the operating interval has expired.
The entire assembly may be pre-manufactured, including all signs and the signpost.
Audible indications of operational status may be included.
The approach speed of an oncoming vehicle may be determined, and the pedestrian and driver warned via audio and/or visual warning if the pedestrian may be endangered by the approaching vehicle.
The assembly can have memory and appropriate electronic communication means to save and report data and statistics to other assemblies and/or to a remote location (e.g., via a computer network such as the internet, the cell phone system, or satellite communications).
The assembly may sense an approaching vehicle and warn the pedestrian and/or cause a delay in activating the warning beacon system until it is judged to be appropriate to attempt to cross. This may be accomplished with vehicle sensors either standing alone or attached to signs upstream of the crosswalk in the traffic flow and integrated into the system by wireless or wired communications, as above. When a vehicle is sensed, a message could be sent to a properly enabled vehicle to cause a warning light and/or tone or other audio message to go off in the vehicle, warning the driver of a pedestrian in the crosswalk ahead. With an appropriately enabled “smart” vehicle, the message could be used to cause a desired action in the vehicle, such as the automatic pre-tensioning of seat belts, the automatic pre-charging or even activation of the brakes, and the automatic sounding of the horn.
Devices and/or software may be integrated into or added on to motor vehicles to provide a warning to the driver through the vehicle audio system.
Devices and/or software may be integrated into or added on to cellular telephones to provide a phone-using driver and/or a cell phone-carrying pedestrian with specific warnings.
Wireless remote control device 60 can be used to allow access to, operation of, and/or programming of, an assembly 10, through transceiver 50 and microcontroller 14a.
Ambient light sensor 30 can be used to control the light illumination level in order to save power.
RFID or personal ID reader 32 can detect a nearby authorized user with an RFID tag or other means of ID such as a card, any of which having an appropriate ID code. This can be used to allow an authorized access to an assembly (for example to enable the assembly, or allow programming of it), and/or to operate the assembly in a particular manner. For example, audible warnings could be issued to a blind person carrying an RFID tag who was approaching a sign enabled with the invention, or the sign could be operated for a longer than normal time if a physically disabled person was in the proximity of the sign assembly.
Second transceiver 40 can be used to communicate with a remote location (for example: a monitoring or control location reached via the cell phone network, satellite communications network or a radio network; an approaching vehicle; a sign that is not part of the two-sign system shown in FIG. 1).

In the preferred embodiment, the system is solar powered and battery operated, although power could be provided by any other means, such as by available AC power. Referring to FIG. 1A, the Solar Collector 24 is connected to Charging Circuit 22a that charges a nominal 8V, 3.2 Ampere-Hour lead-acid storage battery 22b. A diode prevents reverse current flow from the charged battery to the solar collector during periods of low light when the panel voltage is lower than the battery voltage. Operating power is drawn from the battery and, when light conditions are suitable, also from the charging circuit, to operate Switching Power Supply 14b and to supply unregulated power to light LEDs 20 and 18.

There are six LED Driver Circuits, 20a and 18a. Each is individually supplied with an analog reference voltage which is applied to the “+” input terminal of an operational amplifier. This causes the operational amplifier to raise its output voltage, driving the base of the Darlington-connected LED driver transistor and causing current to flow through two series-connected LEDs at TB(n), and a resistor and Shottky diode to ground. The voltage generated by the current flowing through the resistor and Shottky diode is returned to the “−” input of the operational amplifier. This results in a voltage-controlled current drive circuit wherein a high-impedance voltage source is able to drive Amperes of current in a controlled manner. There are no capacitive energy storage elements in the LED Driver Circuits, so their response time is rapid enough to allow their average current to be Pulse Width Modulated (PWM) by rapidly turning them on and off and varying the duty cycle should that method of output control be chosen in addition to the designed-in current control.

Alternatively each LED Driver Circuit may be made from a “Synchronous Boost Converter with I²C Compatible Interface” such as the Texas Instruments TPS61050, serially commanded directly from the microcontroller 14a.

The analog reference voltages for the LED Driver Circuits are supplied by D/A Converters (DAC) 14c. Two 4-channel serial input digital to analog converters are wired to use a single reference voltage derived from the 3V power supply 14b. This reference is used in a controlled manner to drive the pedestrian illuminating LEDs and the strobe LEDs. It is also used in a, possibly different, controlled manner as a secondary reference for the DACs which supply the reference voltages to the warning LEDs. Once the reference levels have been calculated in reference to ambient light levels and other factors, the DACs are turned fully on or fully off to flash the LEDs as needed. In other embodiments they may be used to control light levels of the LEDs.

The Radio 50 is an IEEE 802.15.4 (“ZIGBEE”) “off the shelf” or equivalent proprietary radio system operating in the FCC ISM (Industrial, Scientific, Medical) unlicensed 2.4 GHz frequency band and capable of transmitting a minimum of 100 meters while consuming 50 mA at 3V. It is used for two purposes. In the master sign, it initiates communications with the slave sign or signs, and it also communicates with wireless remote controls 60.

The User Switch 16 is a mechanical or capacitive device used to detect human input.

The microcontroller 14a is a 16-bit microprocessor Texas Instruments MSP430F249 or equivalent, supplied with a 32.4 KHz crystal to provide a stable frequency base for communications.

The Light Sensor 30 is an analog or digital output light sensing device mounted in a weatherproof housing near the solar panel and pointed parallel to the panel in the general direction of the sun. In this embodiment it is a digital sensor and provides a frequency proportional to light intensity which the microcontroller counts over a specified period of time to determine ambient light intensity.

The white strobe LED assembly 112 is mounted closest to the apex of the sign, followed at equal intervals by the four amber warning LED assemblies 113-116. Each LED assembly consists of two LEDs mounted back-to-back and pointing perpendicular to the sign faces. The LEDs in each assembly are wired in series to conserve power.

The four white pedestrian illuminating LEDs 122 are individually mounted in adjustable housings on the solar panel mounting pole extension so that they may be aimed to illuminate the crosswalk and its approach areas.

All parts except the User Switch, Pedestrian Illuminating LEDs, Solar Panel, Battery, and Light Sensor are housed in a weatherproof housing (Control Box) 110 mounted between the two signs and colored black to provide better contrast for the LED lights. All external parts are connected to the Control Box through weatherproof, polarized, keyed connectors using ultraviolet resistant cable.

In operation, when a pedestrian desires to cross the street, the pedestrian activates the pushbutton, which causes the microcontroller to send a radio message to the sign on the other side of the street indicating that a pedestrian has pushed a button. This starts a flashing light sequence. It then waits to begin its own identical sequence until has received an acknowledgment from the other sign, so that the two assemblies may synchronize the flashing of their lights. If no return message is received, the process is repeated for a set number of times, after which, the local sign gives up and flashes its own lights and records the failure to internal memory for later diagnostic use.

If a radio message is received from a remote control device, or a coded pushbutton sequence is entered, a wider variety of display behaviors and communication options are available. Examples include flashing the strobe LED only, or strobing all the LEDs, for example to attract attention to the longer-term presence of a crossing guard or police officer rather than the transient use by a pedestrian.

### Disclosure of Optional Additional “Approaching Vehicle” Technology

This aspect of the invention uses the previously disclosed sign beacons and adds the ability to detect, and potentially to directly communicate with, an approaching vehicle. As a result of such detection, the driver can be notified, either via a flashing lighted sign, or a message or warning tone inside of the vehicle, or combination thereof through a specialized warning/identification device, through the vehicle audio system or, if in use, through the driver's cellular telephone via a distinctive ring or warning tone or combination thereof. If the pedestrian is detected to be carrying an active cell phone, the system can also provide a similar distinctive ring or warning tone or combination thereof.

In an embodiment of this aspect of the invention, a pair of the previously disclosed sign beacon assemblies are situated on opposite sides of a street, typically but not necessarily proximate a crosswalk. Situated an appropriate distance upstream on each side of the street is a vehicle detection device, typically located in a pre-warning (e.g. “Crosswalk 100M”) sign. When a pedestrian requests that the beacon light be activated, radio messages are sent to the vehicle detectors. If a vehicle is detected, the beacon lights may not be activated. Instead, both the pedestrian and driver may be warned, and the crosswalk beacon light not activated until it is deemed safe to cross.

Options for this aspect of the invention include:
The vehicle detection means may be passive with respect to the vehicle (metal detection, ultrasonic sensing, radar, optical. etc.) or interactive with the vehicle or dedicated electronics.
The vehicle detector may include the ability to determine vehicle speed or even velocity so as to more accurately determine safety factors.
The light beacon sign may include a device to determine the presence of an active cellular telephone within a predetermined distance and to activate the cell phone to accomplish a warning device for the pedestrian if a crossing is unsafe. Such activation may be done directly with appropriate communications equipment in both the sign assembly and the cell phone, or through the cellular network.
Pedestrian warning devices other than cell phones may be issued to pedestrians and incorporated in the system, especially in the case of blind or handicapped adults or any children. System behaviors may be modified depending on the type of pedestrian. (e.g., longer “on” time and warning space for those unable to cross rapidly as determined by their warning device type) or the vehicle type (e.g., refusal to activate in the presence of oncoming emergency vehicles).
The vehicle detector may include a device to determine the presence of an active cellular telephone within the vehicle and to activate it as a warning device for the driver if a crossing beacon has been requested or for other desired reasons.
The vehicle detector may include appropriate pre-warning signage, which may itself include beacons or illumination.
The vehicle detector may be solar powered. It may communicate with the beacon signs by any wired or wireless transceiver.
The vehicle detector or the beacon sign may have memory to retain statistical information related to usage, vehicle speed, identification, and times for later retrieval by any technical means or by visual readout.
There may be multiple vehicle detectors on either or both sides of the roadway with spacing limited only by the communications technology.
Various modes of operation of both the beacon sign and the vehicle detector, depending on the time of day, traffic density, battery charge remaining, and other factors are possible.

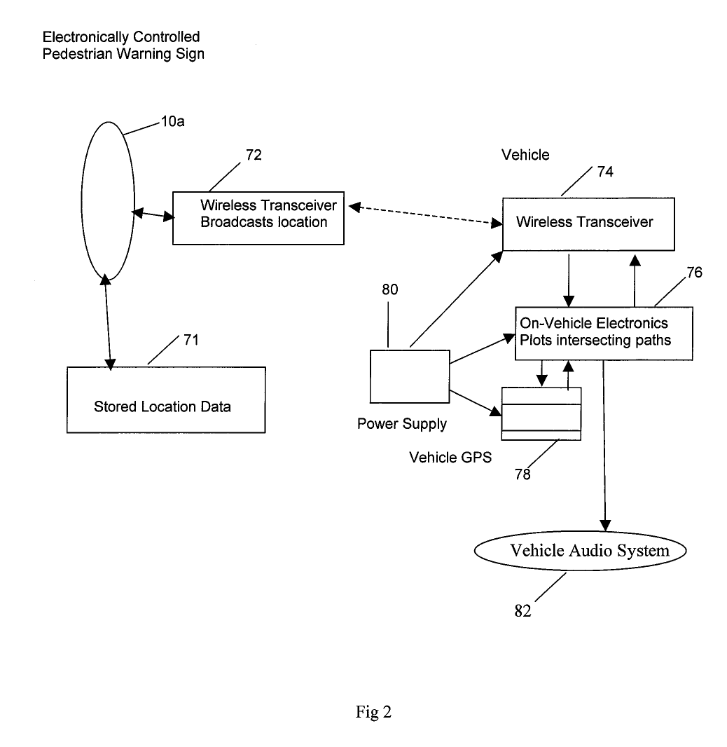

FIG. 2 shows assembly 10a that includes its location stored in memory 71 that is associated with the microcontroller. Transceiver 72 broadcasts the location, which is received by transceiver 74 located in a vehicle. On-vehicle electronics 76, in conjunction with on-board GPS 78, can determine the vehicle's path relative to the sign location, and transmit an appropriate warning to the driver and/or a pedestrian. Vehicle-based devices are powered by vehicle power supply 80.

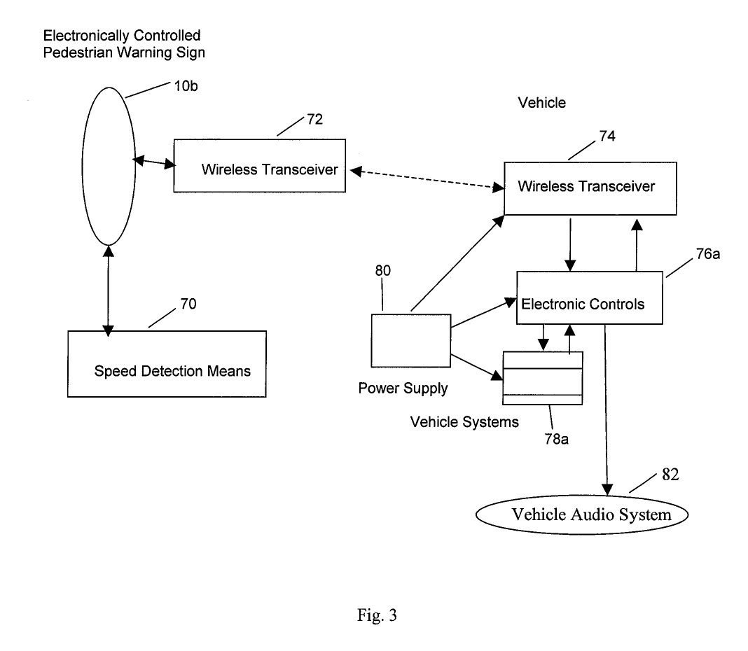

FIG. 3 shows another option in which the sign-based assembly 10b includes a device 70 for detecting the speed of an approaching vehicle; with multiple signs, the velocity can be determined. This allows assembly 10b to send to the vehicle an informational message that can be related to the speed or velocity. The message may warn of the presence of an oncoming sign, and also perhaps the sign activation state and/or location, and/or a warning of the approaching sign and when it will be encountered.

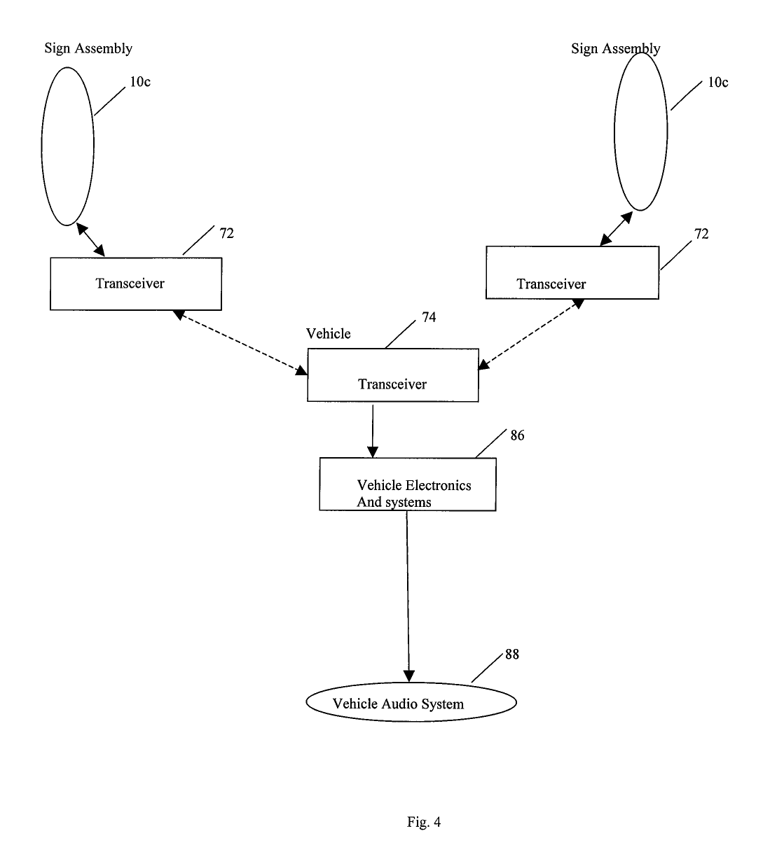

FIG. 4 shows another option, in which there are two or more inventive assemblies 10c, each including a radio transceiver 72 that is capable of measuring received signal strength. An approaching vehicle equipped with a similar transceiver 74 allows the system and the vehicle to exchange information messages and signal strength data. The signal strength and rate of change of signal strength can be used to calculate vehicle velocity relative to the signs and issue appropriately-timed informational messages to the driver through electronics 86 and audio system 88. By using three or more sign-based assemblies, vehicle position can be determined, which allows more accurate information to be provided to the driver and/or the pedestrian.

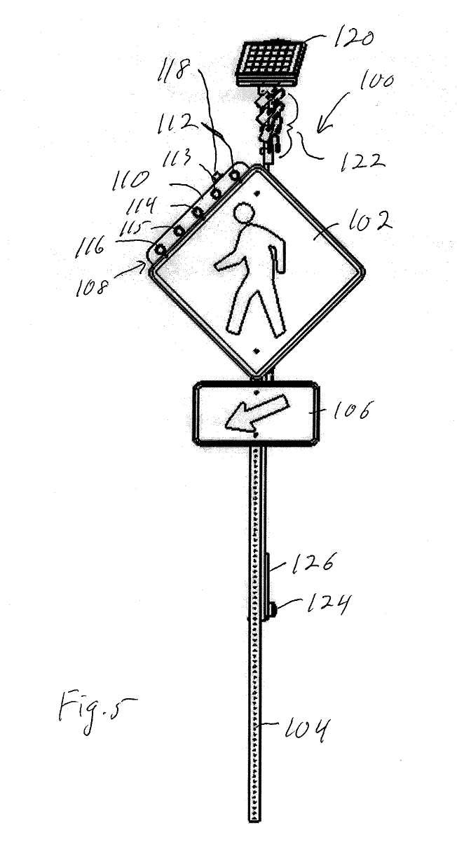

FIG. 5 shows one particular embodiment of an inventive assembly mounted along with a crosswalk sign. Sign post 104 carries pedestrian crossing signs 102 and 106. Sub-assembly 108 includes housing 110 that is mounted to sign 102, or can be sandwiched between two back-to-back signs 102. Housing 110 carries ambient light sensor 118, strobe light 112, and beacon lights 113-116. Pedestrian illumination lights 122 preferably comprise LEDs that are mounted in housings that can be rotated in two dimensions and then locked in place (e.g. with a set screw) so that each light can be aimed where desired, for example down and at slightly different angles to illuminate the length of a crosswalk. Solar collector 120 is mounted at the top of an extension to signpost 104. Pedestrian switch 124 is carried by mount 126 that is attached to signpost 104.

It will be understood that the particular method, device, assembly and system embodying the invention are shown herein by way of illustration and not as a limitation of the invention. The principles and features of this invention may be employed in various and numerous embodiments without departing from the scope of the invention.

Although specific features of the invention are shown in some drawings and not others, this is for convenience only as the features may be combined in accordance with the claimed invention. Other embodiments will occur to those skilled in the art and are within the following claims.

What is claimed is:

1. A vehicle warning system for use in conjunction with road signs located proximate a roadway, the system comprising:
two assemblies, one on each side of a roadway and associated with a road sign, each assembly comprising:
i) a power source;
ii) one or more lights that when lit project light that is visible to a passing motorist;
iii) a controller;
iv) an activation device; and
v) a wireless transceiver;
wherein operation of the activation device of a first of the assemblies causes the wireless transceiver of the first assembly to send a signal to the wireless transceiver of the second assembly, and both controllers to temporarily connect one or more lights of each assembly to the power source for the assembly, to light the one or more lights and thus project light that is visible to a motorist on the roadway.

2. The vehicle warning system of claim 1 in which the power source comprises a battery to store energy.

3. The vehicle warning system of claim 2 in which the power source further comprises a solar collector.

4. The vehicle warning system of claim 1 in which the activation device comprises a pedestrian sensing device.

5. The vehicle warning system of claim 4 in which the pedestrian sensing device is manually operable by a pedestrian.

6. The vehicle warning system of claim 1 in which each assembly has a plurality of lights.

7. The vehicle warning system of claim 6 in which one or more of the lights are vehicle warning lights that are aimed along the roadway in the direction of a vehicle approaching the assembly.

8. The vehicle warning system of claim 7 comprising a plurality of vehicle warning lights mounted to the sign.

9. The vehicle warning system of claim 8 in which the vehicle warning lights are lit sequentially.

10. The vehicle warning system of claim 6 in which one or more of the lights are pedestrian safety lights that are angled downward and aimed at the roadway proximate the sign.

11. The vehicle warning system of claim 10 in which the safety lights are mounted above the sign.

12. The vehicle warning system of claim 10 in which the safety lights are in one or more housings with adjustable aim.

13. The vehicle warning system of claim 1 in which at least some of the lights are LEDs.

14. The vehicle warning system of claim 1 further comprising an ambient light sensor that is used to control the brightness of the lights.

15. The vehicle warning system of claim 1 further comprising a wireless remote control for providing commands to a controller.

16. The vehicle warning system of claim 1 further comprising a speed-determination device that determines the speed of an oncoming vehicle.

17. The vehicle warning system of claim 16 further comprising a wireless communications device, responsive to the speed-determination device, that transmits a message related to the determined speed.

18. The vehicle warning system of claim 17 in which the communications device communicates a desired action to a vehicle.

19. The vehicle warning system of claim 18 in which the desired action includes one or more of pre-tensioning seat belts, pre-charging or activating the brakes, and sounding the horn.

20. The vehicle warning system of claim 17 in which the message is audible and/or visible to a driver.

21. The vehicle warning system of claim 1 in which an action of the system is automatically controlled by detecting a nearby RFID device that has a predetermined ID code.

22. The vehicle warning system of claim 1 further comprising a wireless communications device to allow one-way communication to, or two-way communication with, a remote site.

23. The vehicle warning system of claim 1 further comprising vehicle speed or velocity-determination equipment to determine the speed or velocity of a vehicle on the roadway.

24. The vehicle warning system of claim 23 further comprising a device to issue to the vehicle an informational signal related to the speed or velocity.

25. The system of claim 1 further comprising a device that broadcasts the activation state and location of an assembly.

26. The vehicle warning system of claim 25 in which the broadcast employs satellite communications.

27. The vehicle warning system of claim 1 further comprising a personal device carried by a pedestrian to identify their status as a user for whom the system behavior can change.

28. The vehicle warning system of claim 27 in which the personal device allows the user to enable an assembly.

29. The vehicle warning system of claim 1 in which one or more aspects of light control are adapted to be controlled by a user.

30. The vehicle warning system of claim 29 in which user control is accomplished by coded pushbutton entry sequence, remote control, or downloaded via cellular telephone or satellite.

31. The vehicle warning system of claim 30 in which the coded pushbutton sequence may be changed or disabled using a remote control device.

32. The vehicle warning system of claim 1 in which each assembly is mounted to a sign and/or a post to which the sign is mounted.
